(19) United States
(12) Patent Application Publication
(10) Pub. No.: US 2011/0003548 A1
(43) Pub. Date: Jan. 6, 2011

(54) TECHNIQUE THAT ENABLES EACH OF A SYSTEM OF BLUETOOTH DEVICES TO APPEAR AND FUNCTION, IN RELATION TO CLIENT DEVICES, AS THE SAME ONE DEVICE.

(76) Inventor: Thomas Milne Malcolmson, Toronto (CA)

Correspondence Address: Tom Malcolmson, Ste 304, 1 Benvenuto Place,, Toronto, ON, M4V 2L1, CA

(21) Appl. No.: 12/830,320

(22) Filed: Jul. 4, 2010

Related U.S. Application Data
(60) Provisional application No. 61/222,970, filed on Jul. 3, 2009.

(51) Int. Cl. H04B 7/00

(52) U.S. Cl. 455/41.2

(57) ABSTRACT

Disclosed is a technique that enables each of a system of Bluetooth devices to appear and function as the same one device in relation to client devices. This eliminates any repercussions to the client device or its end-user of obtaining service from multiple devices, such as the need to pair with each. To affect this, the set of devices that comprise the system are reconfigured such that their wireless identities (their BD_ADDR) are the same, and they share information about client devices including their security credentials (their link keys).

### CROSS-REFERENCE TO RELATED APPLICATION

This application claims the benefit of U.S. provisional application No. 61/222,970, filed on 3 Jul. 2009.

### FEDERALLY SPONSORED RESEARCH OR DEVELOPMENT: Not Applicable SEQUENCE LISTING OR PROGRAM

Not Applicable

### BACKGROUND

1. Field of the Invention

The present invention relates in general to the fields of wireless communication, wireless security, and mobile personal computing devices, and more particularly to a method and system that enables a system of a plurality of wireless devices to appear and to function as one wireless device with respect to a client wireless device.

### Bluetooth

Bluetooth is an open standard for lower power, short range wireless communication between computing devices. It uses 79 radio channels of 1 MHz each, covering the range 2402-2480 MHz which is in one of the unlicensed ISM radio bands.

Bluetooth is a frequency hopping protocol which means that a stream of communication taking place between a set of Bluetooth devices is continually changing channels, in this case at a rate of 1600 hops per second. The time that is spent at one frequency is called a slot and is equal to 625 μs (microseconds). This is controlled by an internal clock with a period of 312.5 μs, so there are two clock ticks for every slot.

The clock is based on an oscillator with an accuracy of +/−20 ppm (when not sleeping). A particular oscillator's accuracy is not constant, but the main factor that can change the oscillator's accuracy is the ambient temperature so a set of radios in the same room are likely to speed up or slow down together.

Up to eight devices can actively participate in a coordinated communication session—each of the devices knows what the pattern of channels is and they are synchronized so that they can all change frequency at the same instant. One aspect of that synchronization is the calculation of offsets between their clocks so that every device except one can adopt a new, temporary, synchronized clock.

Multiple sessions taking place in the same physical space are not coordinated and are liable to cause collisions thus reducing efficiency.

### Bluetooth Addresses

Every Bluetooth device has a numeric identifier, or address, known as a BD_ADDR (Bluetooth Device Address). As well as being used as a globally unique identifier the BD_ADDR is also used as an input to some of the protocol's frequency hopping and security algorithms.

The best known and most widely used identifier for networking equipment is the MAC (Media Access Control) address. The BD_ADDR is not a MAC address but it is very similar both semantically and administratively, and they share the same identifier numbering system which is known as the 48-bit extended unique identifier (EUI-48™) and is administered by the Institute of Electrical and Electronics Engineers (IEEE).

At the heart of the EUI-48 numbering system is the Organizationally Unique Identifier (OUI), which is a 24-bit number assigned by the IEEE that uniquely identifies a manufacturer or other organization (an ‘assignee’). The OUI defines a range of addresses within the EUI-48 number space that are reserved for the owner of the OUI. The IEEE later decided on the need to sell smaller blocks of address so they began selling IAB (Individual Address Block) which define a block of just 4096 unique addresses (12 bits worth).

### Bluetooth Security and Pairing

The standard usage pattern for Bluetooth is for two devices to pair before they communicate for the first time. In order to successfully complete the pairing the same PIN codes must be entered on both devices. A successful pairing creates a key—called a link key—that is used as the basis of all security transactions between the two parties. If the pairing is going to be reused then the newly created link key is stored, the devices are said to be ‘bonded’, and they can engage in subsequent communication sessions without having to repeat the pairing procedure. The term bonding shall here after be taken to refer to a BD_ADDR and associated link key.

The standard allows for some alternate methods by which a PIN can be provided to a device—to allow for devices where a user can't enter a PIN—but a device with a keypad and a display, such as a cell phone, requires that the user enter a PIN code manually. The net result is that a user must enter a PIN code every time they want their device to communicate with a new Bluetooth peer. If the ‘peer’ is a peripheral, such as a headset, then this seems natural, but if the peer is one of a set of Bluetooth devices—e.g. providing service to cell phones in multiple locations—then this is unacceptable to the user. This can be compared to Wi-Fi which allows one set of security credentials to be used at multiple access points—the same password works (and without any user interaction) across a network of hotspots that use the same Service Set identifier (SSID).

Bluetooth v2.1 introduces significant changes for Bluetooth security—the most relevant to this discussion is the introduction of Secure Simple Pairing (SSP). SPP has several modes of operation including ones which bypass the need for a user to manually enter a PIN. While this directly addresses the issues being discussed here it does not resolve them for these reasons:

The use of SPP without manual user input is subject to man-in-the-middle (MITM) attacks.

Typically cell phones have a small limit (e.g. 24 or 32) on the number of bondings they can remember and have no ability to manage or display sets of related bondings in a user friendly manner. Even if the process of pairing were completely invisible to the end-user, current phones are not designed to handle very many.

While the user's involvement in the pairing process can be significantly simplified with SPP, the user will still need to initiate or accept the pairing. A new pairing without any user interaction would be unacceptable for security reasons.

There is a very important exception to this requirement for pairing. For communications where either device is Bluetooth 2.0 or prior, a security mode called service level enforced security can be used. As the name implies, this mode allows the Bluetooth service that is using the link to determine the security. On many current (circa 2009) cell phones the L2CAP service allows for data communications without any security. Further, the L2CAP service can be used by an application on the phone for general purpose data communications.

The result is that, for those phones, an application on the phone is free to communicate with any number of other devices without any user interaction at all (the application would provide its own authentication and encryption). This is not considered a security problem because the user authorized the application by installing it.

Unfortunately, some phones don't support this—the Blackberry phones are the most prominent example. As well, the Bluetooth 2.1 specification only allows this when communicating with a Bluetooth 2.0 (or earlier) device, and it is unlikely that Bluetooth 2.1 phones would implement that allowance.

Bluetooth v2.1 introduces a new mode for doing service level security (security mode 4) but this mode builds additional security on top of the (sometimes weak) security of SPP.

So in spite of simplification in the pairing process and some exceptions to the requirement for pairing, the problem remains. Some user interaction is required before any communication can take place between any two devices that haven't already paired, and this interferes with a whole range of possible applications, such as mobile banking, that could have been provided to all cell phones with Bluetooth.

### Bluetooth Security and Keys

When two devices that are already paired want to engage in a new communication session, they must first authenticate. The device attempting to perform the authentication—the verifier—uses the claimant's BD_ADDR, a random factor, and a value that the claimant derives from its stored link key and the verifier's random factor (which was sent to the claimant) as inputs to the algorithm that determines the success of the authentication. What is notable here is that the claimant must have the correct BD_ADDR and link key for the authentication to succeed.

The Bluetooth encryption algorithms require some additional factors but the BD_ADDR and the link key are still the only constant inputs.

Bluetooth defines four different types of “link keys”: the initialization, combination, unit, and master keys. They are all 128 bit keys and can all be used to secure Bluetooth link(s), but they are not all suitable for use in a bonding.

The initialization key is generated during pairing (from the PIN) and is used for an initial exchange before some form of semi-permanent key can be created, at which point it is thrown away. A semi-permanent key is one that can be stored and used for future sessions (i.e. in a bonding). It is called semi-permanent, rather than permanent because it can be changed and it is good practise to do this occasionally.

The unit key is a value that is generated and stored on each device. It qualifies as a potential semi-permanent key but this usage of the unit key has been deprecated since Bluetooth v1.2 since it is not secure.

The remaining option for a semi-permanent key is the combination key which is negotiated during the pairing and is the same for both devices.

The final type of link key is the master key. It is a temporary (can not be stored or used in multiple sessions) key that is used only for point to multi-point communication.

### Cell Phones

The most likely client device to the system described in this invention is the cell phone. The majority of cell phones now have Bluetooth radios. Most also allow applications running on the phone to use the Bluetooth radio. There are hundreds of Bluetooth applications available that harness the phone's Bluetooth radio to provide some form of free data communications, typically with a PC or with other phones.

This invention is of particular relevance to phones that have Bluetooth but don't have Wi-Fi, including almost all feature phones, and most Blackberry smartphones. There are, however, many cases where a phone has a Wi-Fi radio and yet it is still preferable to use Bluetooth.

### DESCRIPTION OF THE PRIOR ART

There are several existing patents that try to deal with the general problem of providing services or resources to a client device through a network of Bluetooth devices. U.S. Pat. No. 7,424,267 to Eisenbach discloses a method, apparatus, and system for automatically sharing data resources between Bluetooth devices, and U.S. Pat. No. 7,020,456 to Smeets, et al discloses a method and system for authentication of units in a communications network. Both use techniques of sharing the security credentials of client devices between the devices in the system. While this is done to some advantage in each, it does not address the need for a new pairing because the BD_ADDR of the devices in their systems remain unique (as is normal), so it is not possible to reuse the link key for link level authentication and encryption.

European Patent EP1511235 to Jeannerod Laurent proposes a solution enabling the use of a personal portable device over a network comprising of terminals allowing a wireless communication with that device without implying each time a new awkward pairing with the terminals. The purpose of this patent is quite similar to the present invention. It does not, however, contemplate the possibility of a system of devices with the same BD_ADDR, but instead proposes that a unique BD_ADDR be allocated for use when communicating with each particular client device. When a client device attempts to use a device of its system, the device's BD_ADDR is dynamically changed to the BD_ADDR that was allocated for that client. Some of the drawbacks of this solution are the need for a separate BD_ADDR with each client device, the consequent inability of a device to service multiple clients, the considerable complexity of implementing such a system and any issues that might arise from such an implementation.

European Patent EP1336276 to Rydbeck Nils et.al discloses a method and apparatus for enabling anonymous communications from a first Bluetooth device to a second Bluetooth device wherein a temporary identification number associated with the first Bluetooth device is obtained and used in transmissions from the first Bluetooth device to the second Bluetooth device. A temporary and randomly generated address provides no clear indication of the particular device transmitting messages. So, while the technique described does take the significant and unusual step of altering the device's address, its purpose is different (anonymity) and it never contemplates using the same address on multiple devices. It should also be noted that the technique of using randomly generated addresses would not be acceptable to the IEEE (who are responsible for allocating addresses).

### Other Publications

### Specification of the Bluetooth System, Bluetooth 2.1+EDR, 26 Jul. 2007, Bluetooth Special Interest Group (SIG).

The BlueZ Bluetooth Protocol Stack http://www.bluez.org/about/
BCCMD Commands, Cambridge Silicon Radio (CSR) Unlimited., September 2005, Published as document ‘bcore-sp-005pe’.

### BRIEF SUMMARY OF THE INVENTION

The system and method of the present invention eliminates unwanted repercussions of using multiple wireless devices for the provision of service to client devices. At its most general, any device providing a wireless service can be substituted without repercussions by giving an alternate device the guise of the original according to the requirements of the protocol.

For Bluetooth, this allows a client device to use a single set of security credentials (the result of a single pairing procedure) across a network of Bluetooth devices. This means that the pairing procedure doesn't have to be repeated at each device, which would likely be an unacceptable nuisance for the end-user.

The first step in affecting this embodiment of the invention is to set the radio identifier (the BD_ADDR) of each device to an identical value. During operation these devices—which now all have the same BD_ADDR—will share information that they gather about client devices, including their BD_ADDR and link key.

### BRIEF DESCRIPTION OF THE DRAWING

FIG. 1 shows an example of a Bluetooth station.

FIG. 2 shows a system of connected Bluetooth stations.

FIG. 3 is an overview of the authentication, pairing, and key management processes that occur when a client device and a station try to communicate, from the perspective of the station.

### DETAILED DESCRIPTION

### Terminology

In the preferred embodiment of the present invention the wireless communications protocol is Bluetooth, and while that is not meant to limit its scope, it is the wireless protocol that will be used for the purposes of illustration and description.

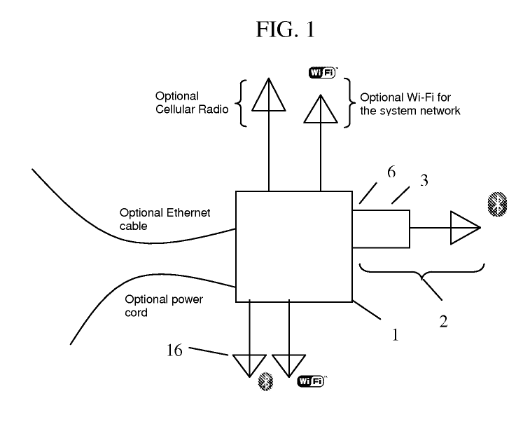

A Bluetooth device is a basic package of Bluetooth functionality and is shown as 2 in FIG. 1. For our purposes it is assumed that the device includes all of the functionality needed to operate either independently or in combination with a host (1), including a controller (3), transceiver, antenna, oscillator, external flash memory, etc., as required. The host is a separate computing unit, with a serial connection to the device, that can implement the upper layers of the Bluetooth functionality. This configuration—with a host and a device, including a controller—is very common and is helpful for illustration, but it is not necessary.

Common examples of a Bluetooth device include a Bluetooth USB dongle and a Bluetooth module with some sort of serial connector. The Bluetooth devices used with mobile electronic devices, such as cell phones, are more highly integrated. A generic Bluetooth communication could be described as taking place between a set of Bluetooth devices.

The compound terms ‘client device’, or ‘client electronic device’ (CED) will be used in a looser and more colloquial fashion to refer to any mobile electronic product that supports Bluetooth. For the purposes of this invention, the client devices are attempting to engage in Bluetooth communication with the set of devices defined by the system.

The client devices are generic Bluetooth products, such as cell phones. The system attempts to provide compatibility with the widest range of these devices possible. It is likely that there is an application loaded on the client device that communicates with software running on the system and with other software that the system provides access to. The system facilitates this communication between the application on the client device and other network based resources, but this is not described further as it is beyond the scope of the present invention.

The use of the term client in ‘client device’ is not meant to suggest anything about its role in the Bluetooth communications, or to suggest that it must always be the consumer rather then the provider of a service.

The system used in this invention includes a set of Bluetooth devices. In the most likely instance of the system—described in detail later and illustrated in the diagrams—the devices are connected such that they are able to communicate with each other to share information. This is not necessary though as the present invention can be used with autonomous devices or even with devices that doesn't exist at the same time. This simpler instance of the system and its techniques are described first.

### Setting the BD_ADDR

The first step in implementing this invention is setting the BD_ADDR of each device participating in the system to the same value. This can be implemented in a variety of different ways but the change is static: each device will have the same BD_ADDR for the lifetime of the system.

The Bluetooth protocol assumes that all devices participating in any Bluetooth communication have unique addresses—the results would otherwise be undefined. As a result, the set of devices with identical BD_ADDR should be deployed so that their areas of coverage do not overlap. Alternatives are discussed near the end of the description.

As with other networking protocols, such as Ethernet and Wi-Fi (which also use the EUI-48 numbering scheme and are governed by the IEEE), the Bluetooth protocol assumes that each device has a unique address. End-user Bluetooth equipment typically provides ways to change the device's BD_ADDR, however changing the BD_ADDR of a set of Bluetooth devices to the same value to create a system of devices with identical addresses, is unheard of. As it turns out though, there are no rules or regulations that prevent it.

The Bluetooth Special Interest Group (SIG) is the organization primarily responsible for Bluetooth and they publish the specification and run the equipment qualification program. It is the IEEE however that is responsible for Bluetooth addresses. They sell blocks of addresses, but they disclaim any control or liability for the manner in which the addresses are used.

One way to pursue this technique—assigning duplicate BD_ADDR—would be to follow these steps. First, to purchase end-user Bluetooth equipment—equipment that is already Bluetooth qualified. Second, to purchase a block of addresses from the IEEE. Third, to change the BD_ADDR of the all of the devices in a set to be one of the purchased BD_ADDR, and to void one purchased address for each device used in this manner (to ensure that the number of addresses purchased is equal to the number of devices deployed).

Assigning purchased addresses to end-user, qualified, Bluetooth equipment in this manner—as opposed to the usual situation where blocks of addresses are purchased for assignment to newly manufactured or new programmed equipment to create a new product—is acceptable to the IEEE. This was confirmed through Carmen Hernandez of the IEEE in New Jersey on 19 Jun. 2009.

Enacting the change of BD_ADDR on a Bluetooth device is an implementation detail, but here are some examples. For Bluetooth devices based on the CSR chipset, their BCCMD protocol can be used to change the value of the BD_ADDR in the device's persistent storage (see the ‘psset’ function, for example). More generally, the BlueZ Bluetooth stack provides a simple command line tool (hcitool) with options for changing a device's BD_ADDR and the source code for this tool is available so the methods used to implement the changes for the different chipsets can be inspected.

Wireless characteristics of the devices—other then their identity—can be duplicated as well. For Bluetooth this is most likely to be dynamic characteristics related to timing and phase, so this is discussed later in relation to the ‘connected’ system.

### Provisioning Client Information

The devices in the set can also be provisioned with information about client devices. This can include both wireless information and application data, though application data is beyond the scope of this invention. For Bluetooth, provisioning the bonding information (BD_ADDR and link key) associated with a client device allows the two devices to perform authentication and encryption without having to go through the pairing procedure.

The method of implementing this depends on the hardware and software that is chosen. Here is an example for systems that use the BlueZ Bluetooth software on the host. Please note though that BlueZ, the manner of its deployment, and the information about its configuration files listed here are not constant so this can not be expected to work on all BlueZ systems.

BlueZ stores information about client devices in files in a directory named “/var/lib/bluetooth/<BD_ADDR>”, where “<BD_ADDR>” is the BD_ADDR of the Bluetooth device rendered as a string with six, two digit hexadecimal bytes separated by colons. Most of the files (including the one with the link keys) have line-separated information about client devices where the client device is designated by its BD_ADDR similarly rendered as a string. Provisioning a device with client information just requires updating (or replacing) these files with information about the client device(s). The link key is stored in a file named linkkeys.

The implementation will be different on other systems, but it should be noted that the Bluetooth specification recommends that the bonding information be stored (as in non-volatile storage) in the host (1 in FIG. 1) and not in the controller (3 in FIG. 1) so it's common for the bonding information to be available on the host, as in this example with BlueZ, and this makes the implementation easier.

### Stations

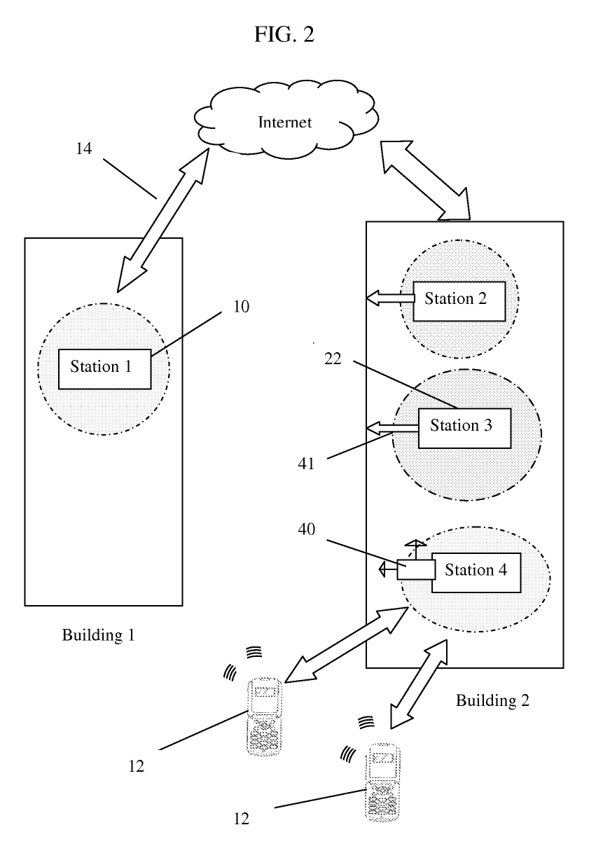

Turning now to the most likely variation of the system: where the devices are connected via a network. FIG. 1 illustrates a station and FIG. 2 illustrates a system of stations. These are components of an implementation of the connected system.

A station is a computing and communications unit that includes the functionality of at least one Bluetooth device. In FIG. 1, 2 is the primary Bluetooth device—the one defined and required by the system—and 1 is a separate computing unit that can act as a host to any of the wireless devices. As illustrated, the station can have any of a variety of optional components, for example, to provide it with power or with a network connection. It can also have additional communication devices for providing user service, as depicted by 16, particularly for users whose client devices are not compatible with or do not require the services of 2.

For the primary Bluetooth device, the device's controller is also illustrated as 3—the fact that no controller is shown for the optional wireless devices is not meant to indicate any distinction between them and the primary Bluetooth device.

The illustration shows a common organization of a station that provides a clear and simple reference for this discussion—it is not meant to limit the nature of equipment that can be used with this invention.

Unqualified references to the Bluetooth aspect or functionality of a station shall be taken to refer to the primary Bluetooth devices, in spite of the fact that the station could have other Bluetooth devices.

FIG. 2 shows a system of connected Bluetooth stations. Though it is not depicted, each station in this figure has the same BD_ADDR. The stations can use some of the optional components from FIG. 1 for power and for their network connection. The station 10 has a cellular device so it can connect to the Internet via the cellular connection 14 (the Internet is used as a convenient piece of network infrastructure). The stations in ‘Building 2’ connect to the Internet via the buildings network and use Wi-Fi (as in 40) or Ethernet (as in 41)to connect to that network. The Wi-Fi device 40 is an 11a or 11n device operating in the 5.8 GHz U-NII band so as to avoid any unnecessary use of the 2.4 GHz band where Bluetooth operates. The shaded circles around the stations depict the radius of their primary Bluetooth radio—note that they do not overlap. Two client devices (cell phones, in this case) are shown as 12, connected to station 4.

### Controllers

This network infrastructure provides a backbone for the communication of information between the stations, including information wireless clients and the state of interactions with them. For the purposes of controlling and managing the sharing of data between the stations it is useful to employ computing devices that function as controllers: software components that manage the communication and caching of information between the stations. For deployments in a single facility there would likely only be one controller, but for larger and more disparate deployments the controllers can be organized into a hierarchy. A station with sufficient computing capacity can perform the role of a controller as well as a station.

When a station has new data that it wants to share with the system it sends it to its designated controller. A controller at any level might validate these data (e.g. against a list of banned client devices) and then append additional information before propagating them. The controller sends these new data to its own controller until the top of the controller hierarchy is reached, and then the top controller propagates the new data back down the hierarchy. When a controller receives the new data on the way back down it can cache them or propagate them down, depending on its configuration.

The degree to which the stations and controllers maintain their own database of information about client devices, rather than always querying their controller, can be configured according to the requirements of the system. Some likely policies would include maintaining the entire database of accumulated information, maintaining just the information about recently seen client devices, or always querying the controller higher up the hierarchy.

### Implementation of the Controllers

The communication between the stations and controllers can be implemented using any communication technology. One option worth considering would be the creation of a custom communication protocol built on top of the network sockets protocol which typically runs on TCP/IP networks. Whatever implementation is chosen it should support secure communication since the data that is communicated will include the security credentials of client devices.

An important consideration in choosing and designing the communications technology and the communication and storage of client device data will be communication latency. Some of the techniques described below will fail if client data is not available quickly enough. More specifically, when a station encounters a new client device, the latency added by querying a controller for that client's data must be small enough so as not to cause the Bluetooth authentication to fail. Depending on the number of client devices using the system and the computing resources available on each station it might be best for the full list of potential clients (including at least their BD_ADDR and link keys) to be maintained on each station.

Ultimately, it is not actually necessary to use a low-latency, modern network. The minimum requirement for this ‘connected’ system is that new information—discovered at one station—about a client device must be propagated with sufficient speed that it is available when the client device appears at another station. There are a lot of variables in that equation, but the client device is likely moving at the speed of a human, so even a system with high latencies could be used under the right circumstances and with the right design (e.g. a suitable controller policy).

### Methods

For this system of connected stations, as with the previously described system of disconnected stations, the stations participating in the system must have their BD_ADDR set to identical values. This technique has already been described.

Other wireless characteristics of the stations can be duplicated as well, including dynamic wireless characteristics. For example, if their clocks were synchronized then a wireless client moving between them would be able to find them more quickly and efficiently because its memory of the offset between its own clock and that of the station would be correct. This is only useful if the client devices moves between the stations before the relative drift (between it and the station) renders its memory of the offset meaningless.

This technique of synchronizing the clocks of the stations is explored in detail below for this and other purposes. However, while it is useful as an example of a technique that would make the wireless characteristics of the stations in the set even more similar, it is not a necessary aspect of the present invention, and it is the other purposes that yield the greatest potential benefit and that are the focus later.

For the sharing of client information in the connected system it is desirable to go beyond the “provisioning” of client data—as described above—and support synchronizing the client data. The network infrastructure and controllers demonstrate a method of moving information, including client data, between the stations, but the bondings must now be handled dynamically and that requires a more complicated implementation.

Most of the functionality described by the Bluetooth specification would be implemented in 3 (the controller) in FIG. 1, but the specification also describes some protocols (the “upper layers”) that would typically be implemented in the host, and it describes the interface between the two. That interface is called the Host Controller Interface (HCI) and would conceptually exist at 6 in FIG. 1. It should be noted that this architecture is very common and is useful for illustration, but it is not a requirement of the Bluetooth specification or of the system being described.

As noted above, the Bluetooth specification recommends that the bonding information be stored in the host and not in the controller. That is facilitated in the HCI which includes all the functionality that a host application needs to manage bondings. So, while there are other ways of implementing this technique, the following discussion refers to the HCI since it is a good option for implementation.

It is also worth noting that the BlueZ Bluetooth software stack—discussed earlier in relation to provisioning client information—is open source software that manages bondings via the HCI interface, so it is a valuable and complete example of all the implementation details needed to manage bondings from the host.

### Interacting with Clients

There are a variety of ways that the interaction between a client device and a station could be initiated. In one scenario the approximate location of any client device is known to the system via carrier location services—these network based services are just starting to become available but are expected to become widespread fairly quickly. When the system determines that a client device is in the area of a station it will instruct one party to begin attempting to find or connect with the other party.

This communication can begin with a Bluetooth inquiry in order to verify that the target device is in range and get its timing information, or it can jump straight to creating a connection with the Bluetooth page operation.

It is likely that the system would instruct the station, rather than the client device, to do the paging to avoid any extra battery consumption on the client device, but there are cases where this could be reversed. Another consideration is that any station that wants to support more than a couple of client devices must take the role of the master in the communication with the client. For some clients, this rules out the option of them doing the paging because they don't support role reversal and would inadvertently create a new piconet if they did the paging.

Leaving that issue aside, we will assume that either device might initiate the connection, but that the station will end up as the master.

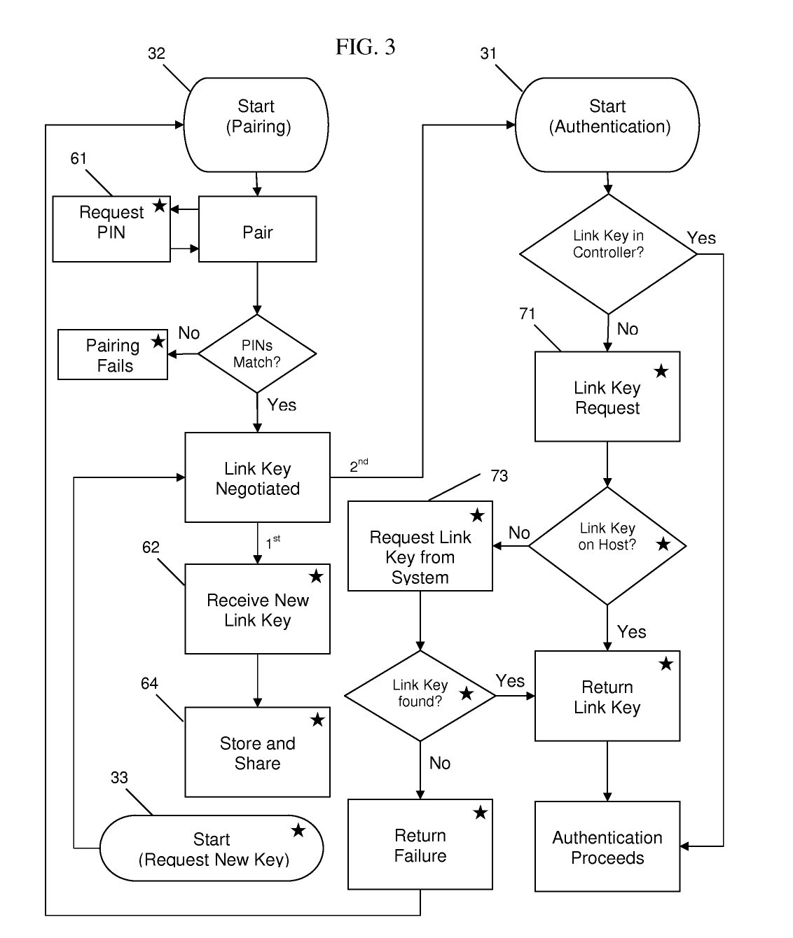

FIG. 3 shows some of the authentication, pairing, and key management processes that occur when a CED and a station try to communicate, from the perspective of the station. The star symbol (★) marks process and decision boxes that would occur on the station's host and would be implemented as part of the solution being described here.

If both devices have access to the bonding information for the other then they are considered to be paired and will successfully authenticate. This process begins at 31 in the illustration. Otherwise, they will have to pair before authenticating—this process starts at 32 but can be proceeded by a failed authentication.

Assuming first that the devices are not bonded and that the pairing process is initiated, the station's controller will request a PIN. At the HCI this will occur as the “PIN Code Request” event at 61. Assuming that the PIN returned to the controller matches the PIN specified on the CED, the pairing will succeed and a new link key will be negotiated and reported as a “Link Key Notification” event at 62. This event includes the BD_ADDR of the peer associated with the new key and the key's type. As discussed in the background, only the combination key and the unit key are suitable for use in subsequent Bluetooth sessions (so there would be no point in storing or sharing the others) and the use of the unit key in this manner has been deprecated.

When a new link key is received and the type has been verified, it needs to be stored and shared (64). It can be (a) pushed down into the controller, (b) stored on the host, and (c) shared with the rest of the system. Option (a) is useful if the devices are about to proceed to authentication, but it is unreliable and it only uses volatile storage. Option (b) is desirable if there is space on the host. Option (c) is a necessary element of this technique, though it can be delayed if desirable. A system for implementing (c) was discussed above.

Note that (a)—pushing a CED's link key into the controller—can also be done pre-emptively: if the system knows that a CED is in the area of a station it can push the link key to the station which can then push it down into the controller. This will result in a faster authentication.

Now that a new link key has been negotiated and reported to the host the controller will initiate a new authentication using the new link key.

On a separate note, a new link key can be created any time that two devices are in communication (when using the HCI, this is done by issuing a Change Connection Link Key command). The starting point 33 occurs when either side requests that a new link key be created. Assuming that the negotiation of a new link key is successful, the station will be notified of the new key as at 62 and then a new authentication will be initiated.

Returning now to the authentication start at 31. As mentioned, this is where the process starts if the devices are already paired.

If the controller already has the link key for the CED in its volatile storage then the authentication can proceed (and will succeed, assuming that the CED is able to perform its role) without any interaction with the host.

The authentication process starts with a request for the link key at 71. If the link key is not available on the host then the host can request it from the system (73). If the controller implementation described earlier was used then this would involve the host requesting the link key for the relevant BD_ADDR from its controller. It is worth noting again that latency would be the critical issue in the implementation of this process.

Returning a failure indication to the system can result in a return to the pairing process. Return a link key allows the control (and the CED) to proceed with the authentication process.

### Limitations and Issues

One limitation in Bluetooth that can affect the system as it has been described so far is that Bluetooth only allows for seven client devices to be actively communicating with a station at a time. Here “client devices” is being used in the Bluetooth sense, not to refer to a CED, and it is assumed that the station has taken the role of the piconet master. In theory, up to 255 client devices can be connected as long as only seven are active—the rest are ‘parked’.

If a station reaches the limit on the number of active clients the first solution is to park any clients that are not actively using the service and that allow themselves to be parked (not all do).

One way that this can be prevented from happening in the first place, is to increase the number of stations and reduce the range of the device with the altered BD_ADDR (other Bluetooth devices on the station might have greater range). When providing a specialized service, as opposed to providing generic hotspot functionality, it will often be desirable to only provide service within a small and well defined physical area.

Another alternative is to create multiple, co-located systems based on different BD_ADDR. This means that a station would have multiple primary Bluetooth devices (where primary means that it is participating in a system as described above) but no two devices on the same station would have the same BD_ADDR. Ideally, a CED is shepherded back to the same system each time they attempt to use the service provided by the systems, but there are circumstances in which they might be required to pair with multiple systems, rather than just one.

The most significant restriction on the system is the requirement that the coverage areas not overlap for any two Bluetooth devices with the same BD_ADDR. This restriction is intended to prevent any two Bluetooth devices with the same address from attempting any communication, and any other device (e.g. a CED) from having simultaneous communication with two devices with the same address.

It is possible, however, for multiple Bluetooth devices with the same BD_ADDR to operate in the same physical space while still avoiding these problematic encounters. It requires that the communications of the devices with the same address be carefully managed.

For the operation of the piconet (as opposed to signalling) there are two main techniques that achieve this. The first is to allocate different segments of the available bandwidth to different devices. This is described in European Patent Application EP1717997 (Decreasing mutual interference between multiple Bluetooth piconets by controlling the channel usage with help of the adaptive frequency hopping methods).

The second technique takes advantage of the fact that the frequency hopping pattern for any piconet in which the master has the same BD_ADDR will be the same (if adaptive frequency hopping is used the channel masks must be coordinated). The relative phase of the stations can then be coordinated to ensure that no two piconets are on the same channel (+/−1, to allow for a guard) at the same time. In order to ensure that the relative phases stay the same it will be necessary to use dynamic crystal trimming.

It should be noted that this technique can be used in the opposite way: rather than keeping multiple devices with the same BD_ADDR off-phase, they can be kept on-phase. This would allow clients that move between the devices more efficiently—their pages would align with a second device's page scans more quickly (unless too much time had passed and their own clock drift negated this attempt at clock coordination). This use will not be pursued any further though.

For either purpose, several things are necessary:
offsets must be calculated between all of the participating devices,
the phase of the clocks must be shifted to achieve the desired affect
the clocks of the devices must be trimmed to minimize the drift between them,
the offsets must continue to be monitored (and the clocks trimmed) to keep their offsets constant.

### A Technique for Clock Synchronization

What is being proposed here is an extension of the preferred embodiment of the invention as described above. The system proposed to affect this extension is not the same system as was used before (though they are compatible) and will be referred to as an auxiliary system. As well, while this technique facilitates an improvement in the main system, it is also a technique that can be used for purposes independent of the main system described above.

It is not possible to implement or easy to describe these techniques using the HCI. Fortunately, additional functionality beyond what is provided in the HCI is available in vendor specific API's—most notably the BCCMD Commands that are documented by CSR plc and supported in their chipsets. CSR claims to control more than 50% of the market for Bluetooth chipsets and products based on their chips are certainly widely and easily available (these observations are made in Spring of 2009), therefore relying on these non-standard API's does not introduce much restriction or risk. These commands are particularly useful for the configuration and synchronization techniques described at the end of the detailed description.

Additional to the Bluetooth devices described for the main system, the stations in this system also have at least one timing device (the functionality of this device could be performed by one of the existing devices, but it would likely be a separate device). In order to be able to coordinate the clocks of all the devices in the system it is necessary that the timing devices, when set to maximum power, be able to communicate with another station, etc. to form a contiguous zone of connections between their timing devices.

For the purposes of the implementation and description of the offset and drift techniques, one device will be designated as the system's master device/clock. Also, one station (or some other computing resource) will need to coordinate these techniques—it will be referred to as the control unit.

Note that none of the devices in the system are allowed to use their low power oscillator (LPO) due to its decreased accuracy. For our system, each device's CLKN will be driven by the reference crystal oscillator, which has a worst case accuracy of +/−20 ppm (according to the Bluetooth 2.0 specification).

The ‘neighbor discovery’ procedure is used to generate a layout or map of the devices so we know which devices are close enough to each other that they can communicate. This procedure includes the following steps:
1. Each station reports its list of devices to the control unit. Co-resident devices should be hard-coded as such.
2. All devices are put into inquiry scan and set to maximum transmit power.
3. Each device performs inquiry to discover neighbours (sequentially for simplicity).
4. Results are put into a “neighbour” database in the control unit. Warnings can be generated for devices that have no neighbours (or much less than the system average).

The ‘clock trimming’ procedure can be used to reduce the relative drift between the Bluetooth clocks in the system. This procedure includes the followingin steps:
1. Each device is put into page scan mode and left at maximum power.
2. One device and its clock (preferably near the middle of the layout) is designated as the system's master device/clock.
3. The master device's neighbours will connect to it and perform the BCCMD Sync_Clock operation as necessary to set their crystal trim.
4. All other devices will connect to the nearest ‘trimmed’ device (attempting 1st to minimize steps from the master device).

5. Since devices have multiple possible sync sources (assuming more than 1 neighbour each), it would be possible to change the master and redo the whole thing, and since this process is not deterministic, redundant measurements could be taken and the results averaged.
6. The clock trim results are stored in the control unit database. If trim results for a device change a lot in one day, that device might be faulty. When deviation is detected (e.g. during the day) then the deviation value can be used to update the trim.

The ‘offset calculation and synchronization’ procedure is used to calculate the offsets between all of the devices in the system and, if desired, adjust the clocks of particular devices so as to achieve a desired offset. This procedure includes the following steps:
1. This procedure starts by using the same steps as for clock trimming, but for this procedure we just calculate the offset instead of doing the Sync_Clock operation.
2. Devices attached to the same computing device can calculate their relative offset on the station (i.e. without any device transmissions).
3. If a particular clock offset is desired (between any two devices) it can be achieved in one of two ways. One way is for the devices' stations to calculate the time between issuing a cold reset and clock 0, and then to use that information to coordinate the time at which they issue another cold reset command in order to achieve the desired offset. The other way is for one of the devices to have its clock temporarily accelerated or decelerated (via trimming) until the desired offset is achieved.
4. Following these steps, each device can calculate its offset relative to the other devices on its station and relative to its neighbouring devices.
5. This allows each device to calculate its clock offset relative to the primary clock and these values are stored in the control unit.

The ‘monitor clock offsets’ procedure ensures that the offsets remain relatively constant. Even if the clocks have been trimmed—as outlined in the clock trimming procedure—the offsets between them will not remain constant unless they are periodically monitored and corrections are applied.
1. For devices attached to the same station, HCI level code will monitor the offsets on the device (i.e. without any device transmissions). Note that this will keep timing and non-timing devices coordinated on each station.
2. Timing devices connect to each other (e.g. they are each a slave and some are masters to one or more slaves). Here are some notes on the topology of the connections. The system should be equipped with enough timing devices so that there is at least one timing device connected to each computing device. There must be a continuous path of offset monitoring that connects all of the stations in the system. The algorithm that decides which other timing devices to connect to should minimize distance from the primary clock device. As a result, the path of connections will probably look the same as the path used in the above steps: a star formation leading from the primary. Depending on the accuracy required, the primary clock device could be a long range device and all of the timing devices could connect to it (with most parked at any one time) so that this process never gets more than one step away from the primary clock.
3. These timing devices remain part of the piconets all day. Note that they can sleep, park, etc. as long as they monitor the offset at a specific frequency. Note also that devices in sleep or park modes can switch to their LPO clock and this must be prevented.
4 . The timing devices regularly verify the offset between themselves and the other devices on the station.
5. Each station maintains an offset between the clock of each of its devices and the master clock. When it sends clock information to, or receives clock information from the control unit it uses these offset values to convert between the system clock (which the control unit uses) and the clocks of its own devices.

The ‘drift reduction’ procedure follows upon the previous monitoring procedure and tries to manage any drift that is detected and keep the offsets constant. The steps listed for this procedure would occur when the previous procedure detects that an offset has changed.
1 . Modify the trim value for the timing device on the fly (using Ana_Ftrim_Readwrite).
2. Mark this timing device as being temporarily out-of-sync (assigns it a temporary offset correction). If it detects that the timing device becomes even more out of sync with its master then it applies more correction. When the timing device comes back in sync it removes the correction. When the other devices on the station are checked, the correction is taken into account: in other words, it is assumed that only the timing device slave is wrong.
3. A record of the deviation and the new trim value is sent to the control unit (this value will likely oscillate).
4. A record of the error is recorded because the device might need to be discarded.

What is claimed is:

1. A method of giving a uniform wireless appearance and functionality to a wireless device in a group of plurality of wireless devices, with respect to a client wireless device, the method comprising steps of:
changing the wireless characteristics, including the identification, of the wireless device to match with that of the other wireless devices in the group;
synchronizing the characteristics of the wireless device with other wireless devices in the group of plurality of wireless devices, where possible and advantageous; and
copying information about the client device, including state of interactions of the client device with the group of plurality of wireless devices, from the wireless device to the other wireless devices in the group.

2. The method according to claim 1, wherein the wireless device communication protocol is Bluetooth and the wireless characteristics of the wireless devices in the group of wireless devices, includes the BD_ADDR and the information about client devices includes their BD_ADDR and their link key.

3. A system that allows client wireless devices to switch connection between a first wireless device to a second wireless device in a plurality of wireless devices without the normal repercussions of their being different wireless devices, comprising:
a set of a plurality of wireless devices having wireless characteristics, including identification, altered to achieve a uniform wireless appearance and functionality, according to the method of claim 1;
a communication network which allows the plurality of wireless devices to communicate with each other; and
a means for sharing information about the client wireless device from the first wireless device to the second wireless device in the plurality of wireless devices.

4. The system according to claim 3, wherein the protocol of the wireless devices is Bluetooth, the wireless characteristics include the BD_ADDR and the information that is communicated from the first wireless device to the second wireless device includes the BD_ADDR and link key of each paired client device.

5. A method for the purpose of making a system of connected wireless devices, according to claim #3, which appear and function as if each were the same one wireless device, in relation to client wireless devices, which comprises
setting the wireless characteristics, including the identity, of all the devices in the system to be the same; and
keeping other wireless characteristics of the devices in the system synchronized via communications over the network, where advantageous; and
sharing information about wireless client devices via communications over the network; and
applying said shared information, as necessary, at each wireless device

6. The method according to claim #5, wherein the wireless protocol of the devices is Bluetooth, so the identifications of the devices includes the BD_ADDR and the information about the wireless client devices that is shared includes their BD_ADDR and link key.
